(19) United States
(12) Patent Application Publication
(10) Pub. No.: US 2009/0245418 A1
(43) Pub. Date: Oct. 1, 2009

(54) TRANSMITTER USING CARTESIAN LOOP

(75) Inventor: Takafumi YAMAJI, Yokohama-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Kabushiki Kaisha Toshiba

(21) Appl. No.: 12/403,534

(22) Filed: Mar. 13, 2009

(30) Foreign Application Priority Data
Mar. 25, 2008 (JP) 2008-078739

(51) Int. Cl. H04L 25/03

(52) U.S. Cl. 375/297

(57) ABSTRACT

A transmitter includes a signal generator to generate a digital baseband signal corresponding to a signal to be transmitted, a digital-analog converter to convert the digital baseband signal into an analog baseband signal by operating in accordance with a clock signal, a subtracter to subtract a feedback baseband signal from the analog baseband signal to generate a residual signal, a loop filter to filter the residual signal by amplifying a low-frequency component and suppressing a high-frequency component, a modulator to modulate the filtered signal by multiplying the filtered signal, a power amplifier to amplify the modulated signal, a high frequency filter to filter the amplified modulated signal to obtain a transmit RF signal, the high frequency filter having a passband width narrower than a frequency of the clock signal, and a demodulator to demodulate a feedback RF signal which is divided from the transmit RF signal.

### CROSS-REFERENCE TO RELATED APPLICATIONS

This application is based upon and claims the benefit of priority from prior Japanese Patent Application No. 2008-078739, filed Mar. 25, 2008, the entire contents of which are incorporated herein by reference.

### BACKGROUND OF THE INVENTION

1. Field of the Invention

The present invention is related to a transmitter using Cartesian loop, which is suitable for integration.

2. Description of the Related Art

Generally, in a wireless transmitter using a direct conversion scheme, a transmit baseband signal is converted into an analog signal by a digital-analog converter (DAC). Since the signal output from the DAC is in a stepped waveform, to obtain a smooth analog signal waveform, a baseband filter is used. In other words, in the output signal of the DAC there are undesired components which exist near frequencies of an integral multiple of a sampling frequency. These undesired components are removed by the baseband filter. The output signal of the baseband filter is input to a quadrature modulator. The modulated signal output from the quadrature modulator is amplified by a power amplifier. The signal output from the power amplifier is transmitted by an antenna after a harmonic component of a carrier signal is removed therefrom by a high frequency filter which suppresses undesired radiation.

Consumption power of a digital circuit increases in proportion to a clock frequency. Therefore, a radio such as a mobile radio terminal which is typified by a cellular phone using battery as a power source was conventionally designed to operate with a low clock frequency as much as possible. However, due to further development in the semiconductor micromachining technique, such design is being reassessed. Firstly, due to the miniaturization of semiconductor microchips, clock frequencies which are operable in digital circuits are becoming higher. Meanwhile, power consumption of individual transistors is decreasing along with the reduction in the size of transistors. Because of this, in some cases, total consumption power of the radio can be made smaller if an analog circuit is reduced by operating a part of the digital circuit in high speed.

Production cost per unit area of a semiconductor chip generally tends to rise as miniaturization advances. Therefore, a relative cost of a device such as a baseband filter whose area is determined by a factor which is different from a processing technique of a semiconductor, such as by thermal noise, tends to rise. Accordingly, in order to provide a wireless transmitter inexpensively, it is desirable to simplify the baseband filter as much as possible, or not to use the baseband filter.

Japanese Patent No. 3419484 (U.S. Pat. No. 5,534,827, U.S. Pat. No. 5,714,916 and U.S. Pat. No. 5,767,750) discloses a wireless transmitter which operates by a high-speed clock and uses a high oversampling DAC such as a ΔΣ modulation-type DAC. In Japanese Patent No. 3419484, the baseband filter can be omitted or simplified by increasing the clock frequency of DAC and excluding an undesired component generated in the DAC from the passband of a high frequency filter.

P. B. Kenimgton, et al., “Noise performance of a Cartesian loop transmitter”, IEEE Transactions on Vehicular Technology, Vol. 46, No. 2, pp. 467-476, May 1997, discloses a Cartesian loop which is one of a linearization technique of a power amplifier. However, it does not consider suppressing undesired components generated in the DAC.

In the transmitter disclosed in Japanese Patent No. 3419484, depending on the condition of the frequency, undesired components may be generated near the frequency of a transmit RF signal in a modulator or a frequency converter. Specifically, in some cases, a mixed component of a harmonic component of a DAC clock signal and a carrier signal or a harmonic component of a carrier signal (frequency component of difference or summation) may become mixed in the band of a high frequency filter as an undesired component.

### BRIEF SUMMARY OF THE INVENTION

According to an aspect of the present invention, there is provided a transmitter comprising: a signal generator to generate a digital baseband signal corresponding to a signal to be transmitted; a digital-analog converter to convert the digital baseband signal into an analog baseband signal by operating in accordance with a clock signal having a predetermined frequency; a subtracter to subtract a feedback baseband signal from the analog baseband signal to generate a residual signal; a loop filter to filter the residual signal by amplifying a low-frequency component and suppressing a high-frequency component; a modulator to modulate the carrier signal by multiplying the filtered signal; a power amplifier to amplify the modulated signal; a high frequency filter to filter the amplified modulated signal to obtain a transmit RF signal by removing at least a part of an undesired component included in the amplified modulated signal, the high frequency filter having a passband width narrower than the predetermined frequency of the clock signal; and a demodulator to demodulate a feedback RF signal which is divided from the transmit RF signal.

According to another aspect of the present invention, there is provided a transmitter comprising: a signal generator to generate a digital baseband signal corresponding to a signal to be transmitted; a digital-analog converter to convert the digital baseband signal into an analog baseband signal by operating in accordance with a predetermined frequency clock signal; a subtracter to subtract a feedback baseband signal from the analog baseband signal to generate a residual signal; a loop filter to filter the residual signal by amplifying a low-frequency component of the residual signal and suppressing a high-frequency component of the residual signal to generate a filtered signal; a modulator to modulate the filtered signal by multiplying the filtered signal by a carrier signal to generate a modulated signal; a power amplifier to amplify the modulated signal to obtain an amplified modulated signal; a demodulator to demodulate a feedback RF signal which is divided from the amplified modulated signal by using the carrier signal to generate the feedback baseband signal; and a high frequency filter to filter the amplified modulated signal to obtain a transmit RF signal by removing at least a part of an undesired component included in the amplified modulated signal, the high frequency filter having a passband width narrower than a frequency of the clock signal.

### BRIEF DESCRIPTION OF THE SEVERAL VIEWS OF THE DRAWING

FIG. 1 is a block diagram showing a wireless transmitter according to a first embodiment.

FIG. 2 explains various frequency components output by a DAC and frequency characteristics of a baseband filter.

FIG. 3 explains undesired components included in the output of the DAC and frequency characteristics of a high frequency filter.

FIG. 4 explains undesired components included in the output of the DAC which uses a high sampling rate and frequency characteristics of a high frequency filter.

FIG. 5 explains a mixed component of a harmonic component of a clock signal and a carrier signal or a harmonic component of a carrier signal, which is included in the output of the DAC, and frequency characteristics of a high frequency filter.

FIG. 6 explains frequency characteristics of a loop filter.

FIG. 7 is a block diagram showing a wireless transmitter according to a second embodiment.

FIG. 8 is a block diagram showing an example of a quadrature modulator.

FIG. 9 is a block diagram showing an example of a quadrature demodulator.

FIG. 10 is a circuit diagram showing an example of a three-phase modulator.

FIG. 11 is a circuit diagram showing an example of a three-phase demodulator.

FIG. 12 is a circuit diagram showing an example of a current output-type three-phase DAC and a current output-type three-phase demodulator.

### DETAILED DESCRIPTION OF THE INVENTION

Embodiments of the present invention will be explained in detail with reference to the drawings, as follows.

### First Embodiment

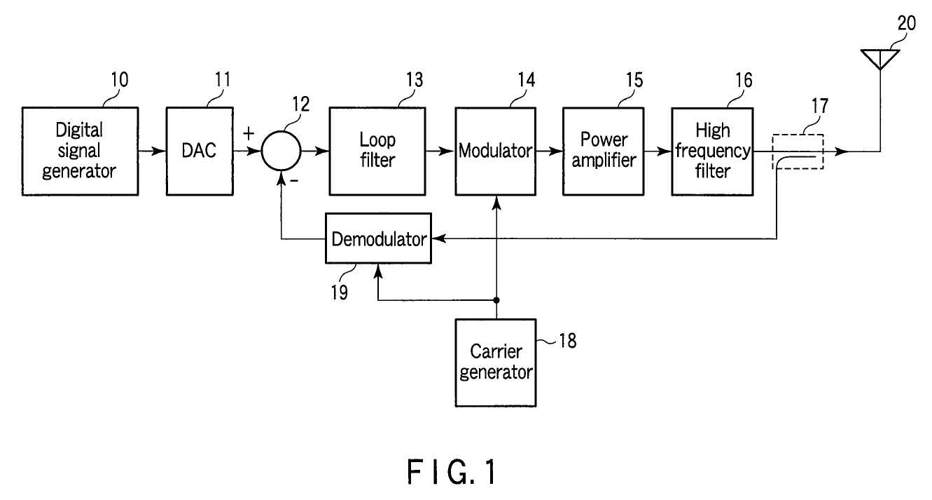

FIG. 1 shows a wireless transmitter according to a first embodiment of the present invention. A part of or all of the elements excluding the antenna of this wireless transmitter may be realized by an integrated circuit. A digital signal generator 10 modulates, for example, signals to be transmitted, such as sound or mail, and generates a digital baseband signal having a signal waveform which conforms to a modulation scheme used by a wireless communication system. For example, in a case where a code division multiple access (CDMA) scheme is used, the digital signal generator 10 multiplies a signal to be transmitted by a spread code. In a case where an orthogonal frequency division multiple access (OFDM) scheme is used, an inverse fast Fourier transformation (FFT) is performed.

The digital baseband signal generated by the digital signal generator 10 is converted into an analog signal (an analog baseband signal) by a digital to analog convertor (DAC) 11. As the DAC 11, it is suitable to use an over sample-type DAC such as a ΔΣ modulation-type DAC which uses a sample rate that is higher in comparison to the frequency baseband of an input signal.

The sample rate of the DAC 11, i.e., the frequency of a clock signal used by the DAC 11, is chosen to be higher than a passband width of a high frequency filter 16 of a later step. By choosing the sample rate of the DAC 11 in such manner, an undesired harmonic component (hereinafter referred to simply as undesired component) which is generated in the DAC 11 can be removed by the high frequency filter 16. The DAC 11 can also be provided with a sample rate conversion function to convert the sample rate to a higher rate, and a filter function which utilizes the frequency characteristics of an output buffer included in the DAC 11.

The analog baseband signal output from the DAC 11 is input to a positive input terminal of a subtracter 12. A feedback baseband signal is input to a negative input terminal of the subtracter 12. Accordingly, the subtracter 12 subtracts the feedback baseband signal from the analog baseband signal and generates a residual signal. The residual signal output from the subtracter 12 is input to a loop filter 13. As the loop filter 13, for example, an active filter which has high gain in a specific frequency such as an integrator using an operational amplifier is used. More specifically, the loop filter 13 generates a filtered signal by amplifying a low-frequency component of the residual signal with high gain (loop gain) and suppressing a high-frequency component of the residual signal.

The filtered signal output from the loop filter 13 is multiplied in a modulator 14 by a carrier signal from a carrier generator 18. In other words, by modulating the carrier signal, the filtered signal is converted into a modulated signal having the same frequency as a transmit RF signal. The modulator 14 multiplies a modulating signal (the filtered signal from the loop filter 13) by the carrier signal, by, for example, a transistor whose switch operation is controlled by the carrier signal. In this case, the modulated signal output from the modulator 14 includes an odd-order harmonic component.

The modulated signal from the modulator 14 is amplified by a power amplifier 15. The amplified modulated signal output from the power amplifier 15 is input to a high frequency filter 16 which generates the transmit RF signal by removing the harmonic component. Here, the passband width of the high frequency filter 16 is chosen narrower than the frequency of the clock signal used in the DAC 11. In other words, as mentioned earlier, the frequency of the clock signal used in the DAC 11 is chosen higher than the passband width of the high frequency filter 16.

The transmit RF signal output from the high frequency filter 16 is transmitted to an antenna (transmit antenna) 20 via a power divider 17, and transmitted as a radio wave. As the power divider 17, for example, a coupler is used.

In the power divider 17, a part of the power of the transmit RF signal output from the high frequency filter 16 is divided and input to a demodulator 19 as a feedback RF signal. In the demodulator 19, the feedback RF signal is demodulated using the carrier signal from the carrier generator 18, thereby generating a feedback baseband signal. As mentioned earlier, the feedback baseband signal is given to the negative input terminal of the subtracter 12.

Here, the subtracter 12, the loop filter 13, the modulator 14, the power amplifier 15, the high frequency filter 16, the divider 17 and the demodulator 19 are connected in a loop, thereby forming a feedback loop (negative feedback loop). In the case where a signal to be handled is an I (In-phase)/Q (Quadrature-phase) signal, this feedback loop is called a Cartesian loop, such as is particularly described in P. B. Kenimgton, et al., “Noise performance of a Cartesian loop transmitter”, IEEE Transactions on Vehicular Technology, Vol. 46, No. 2, pp. 467-476, May 1997.

As it is well known, in the case where the gain of a feedforward pass is sufficiently large, the entire feedback loop operates so that the feedback signal coincides with the input signal. As a result, the gain from the input to the output of the loop coincides with an inverse number of the gain of the feedback path. Further, since the feedback loop operates so that the feedback signal coincides with the input signal, even if noise or error occurs in the output section of the loop, a feedback to negate the noise and error is applied.

Now, the operation and advantage of the wireless transmitter according to the present embodiment will be explained in detail.

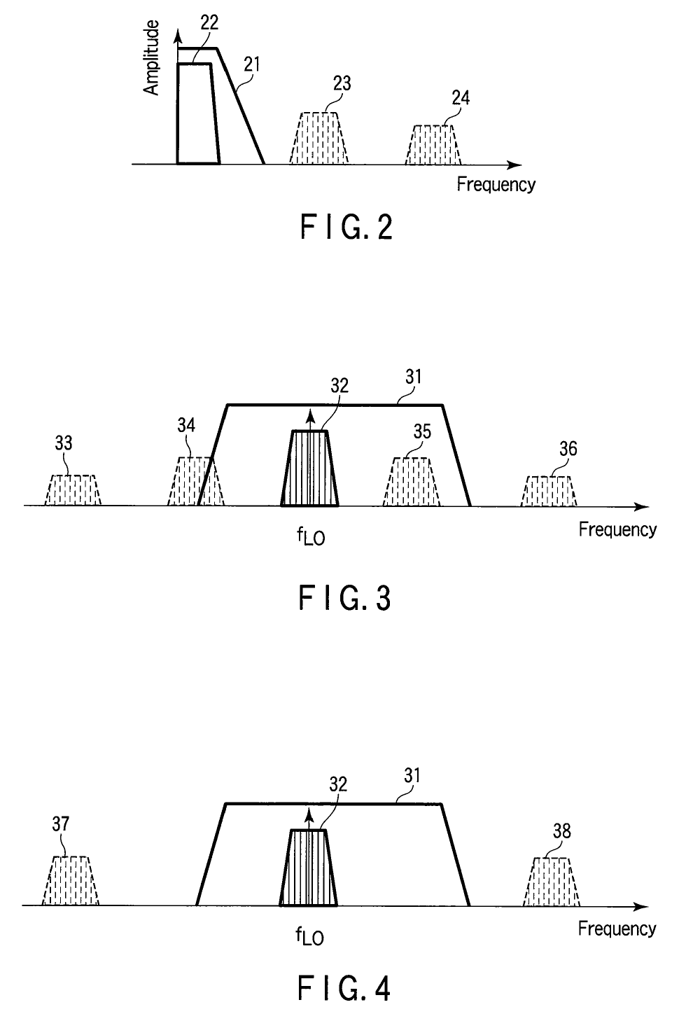

Firstly, again, the problems in conventional art will be explained. In the output of the DAC which converts a digital baseband signal into an analog baseband signal, as shown in FIG. 2, in addition to the signal component 22 to be transmitted, there are undesired components 23 and 24 near an integral multiple frequency of a sampling frequency. These undesired components 23 and 24 are referred to as alias components or image components.

According to the conventional art, these undesired components 23 and 24 are removed by a baseband filter having frequency characteristics 21 whose passband is low-pass as shown in FIG. 2. The output signal of the baseband filter is input to a quadrature modulator. The modulated signal output from the quadrature modulator is given a frequency characteristic 31 as shown in FIG. 3 via a power amplifier and transmitted to an antenna after a harmonic undesired component is removed by a high frequency filter which passes only a signal component 32 through. The harmonic components which appear in the output of the DAC appear as undesired components 33 to 36 shown in FIG. 3 in the output of the high frequency filter. If there is a baseband filter on the output side of the DAC, the undesired components 34 and 35 which exist in the passband of the high frequency filter are removed by the frequency filter.

Meanwhile, in Japanese Patent No. 3419484, a baseband filter is omitted by using a high oversampling DAC to exclude the undesired components 37 and 38 which are output from the DAC from the passband of the high frequency filter as shown in FIG. 4. However, in the technique disclosed in Japanese Patent No. 3419484, depending on the frequency of the clock signal used in the DAC and the frequency of the carrier signal used in the modulator, the mixed component of the harmonic component of the clock signal generated in the DAC and the carrier signal or the harmonic component of the carrier signal becomes close to the frequency of the transmit RF signal. This mixed component is amplified likewise the original transmit RF signal and emitted from the antenna.

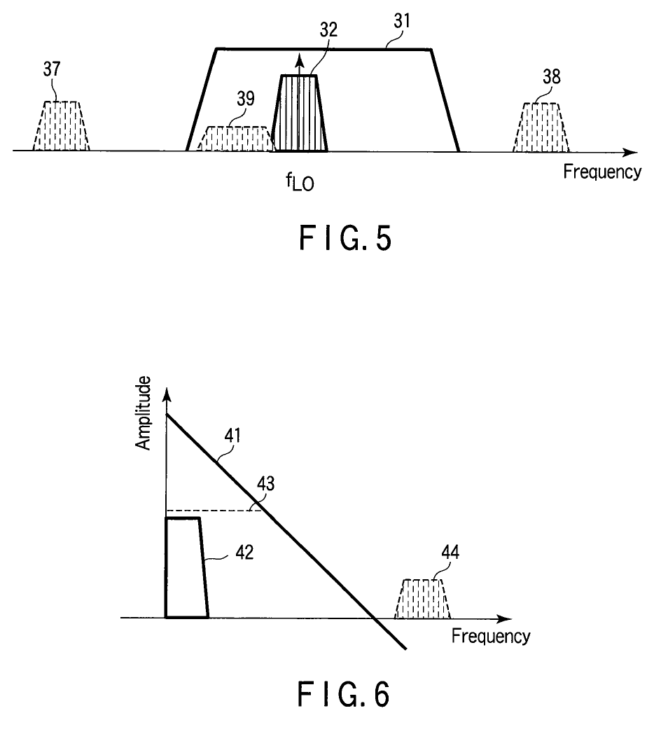

For example, in the case where the frequency of the clock signal is 110 MHz and the frequency of the carrier signal is 830 MHz, 110 MHz×15−830=820 MHz is obtained. Thus, a difference frequency component of 820 MHz becomes mixed in the band of the high frequency filter as an alias component 39 as shown in FIG. 5. Here, an example is given in which a mixed component (a difference frequency component) of a harmonic component of a clock signal and fundamental component of a carrier signal is mixed in the band of the high frequency filter as an alias component. However, in some cases, a mixed component of the harmonic component of the clock signal and the harmonic component of the carrier signal may become the alias component.

According to the present embodiment, advantages such as, (a) while simplifying a baseband filter, or without using a baseband filter which takes up a large occupied area, (b) the occurrence of undesired components which cannot be removed by the high frequency filter, and caused by mixed components of a harmonic component of the clock signal of the DAC and a carrier signal or a harmonic component of the carrier signal, can be prevented. The reasons will be explained in detail as follows.

Firstly, the reason why a baseband filter is unnecessary, or the baseband filter may be simplified in the present embodiment, as mentioned in (a), is as follows.

The consumption power of the digital circuit decreases in inverse proportion to the clock frequency. Therefore, as mentioned in the paragraph of the background art, conventionally, a method to prevent the occurrence of alias was carried out by performing digital-analog conversion in a low sample rate with respect to a digital baseband signal to be transmitted and removing the harmonic component occurred during the digital-analog conversion by an analog baseband filter.

Meanwhile, in the present embodiment, by taking advantage of the progress in the semiconductor microfabrication technology which has facilitated speed enhancement of the digital circuit and DAC, the DAC 11 is operated by a high-speed clock, which specifically is to operate the DAC 11 by a clock signal which has a higher frequency than the passband width of the high frequency filter 16, as mentioned above. In this manner, the occurrence of undesired components which become an alias can be prevented by the high frequency filter 16, and the baseband filter may become significantly simplified or unnecessary.

The advantage of (b) according to the present embodiment is explained as follows. In the transmitter in FIG. 1, an active filter which has a high gain with low frequencies as in, for example, an integrator is used as a loop filter 13. This will allow the feedback loop to have high loop gain. Because of this, the noise and error which occur in the modulator 14 and the power amplifier 15 are compressed by the effect of the loop gain of the feedback loop. For example, as an undesired component which occurs in the modulator 14, a mixed component of a harmonic component of the clock signal and the carrier signal or a harmonic component of the carrier signal, which occurs in the DAC 11 and passes though the loop filter 13, is considered.

Firstly, the frequency characteristic itself of the loop filter 13 provides an advantage of removing an undesired component having high frequency which occurs in the DAC 11. Further, even if the undesired component is mixed with the carrier signal and converted into an alias component having low frequency in the modulator 14, an advantage of suppressing the undesired component by a high loop gain of the feedback loop can be expected.

In this manner, the advantages of both the frequency characteristics of the loop filter 13 and the loop gain can reduce the undesired component itself which occurs in the DAC 11, or the influence of the mixed component of the harmonic component output when the undesired component passes through the loop filter 13, and the carrier signal or the harmonic component of the carrier signal. In other words, such mixed component can be prevented from appearing near the band of a desired signal as shown in FIG. 5, and, as a result, a similar characteristic as shown in FIG. 4 is realized.

In a wireless transmitter which does not have a feedback loop as shown in FIG. 1, in other words, which only has a feed forward path, even if the sample rate in DAC is increased, there is a possibility that a mixed component of an alias component and a carrier signal or a harmonic component of a carrier signal may exist in the band of a high frequency filter. Accordingly, a baseband filter was necessary to remove the alias component from the output of the DAC. In contrast, the wireless transmitter according to the present embodiment comprises a feedback loop to suppress the undesired component occurred by multiplying the harmonics, thereby realizing notable simplification of the baseband analog filter.

In the present embodiment, instead of using a baseband filter (anti-alias filter) to remove the harmonic component from the output signal of DAC 11 as mentioned above, it requires a loop filter 13. Here, conventionally, since it had been necessary for a baseband filter to secure attenuation required in a stopband while realizing a flat frequency characteristic in the passband, it had been difficult to realize this in a simplified circuit. Meanwhile, the loop filter 13 used in the present embodiment does not require a flatness in gain such as is required in the baseband filter.

For example, as indicated by the frequency characteristic 41 in FIG. 6, the integrator has a sufficiently high gain in the band (passband) of an input signal 42, but does not have flatness in the passband likewise the baseband filter. Meanwhile, if the loop filter 13 uses an integrator having such characteristics, the effect of the feedback loop is exercised, and, in a frequency having sufficiently high loop gain, the entire gain is determined by the gain of the feedback path. Therefore, a flat frequency characteristic shown by dotted line 43 in FIG. 6 can be easily realized. Further, as shown in FIG. 6, since the undesired component 44 which occurs in the DAC 11 is in the stopband of the loop filter 13, it does not become an alias.

In this manner, a simple circuit such as an integrator can be utilized for the loop filter 13. Therefore, particularly, in the case of realizing a transmitter by an integrated circuit, a chip area can be reduced. As a method to realize the loop filter, there are a number of reports of prototype examples of AS modulation-type ADC using a method to connect the integrator in multiple stages, or a method to have the loop filter have a resonance character which has a high gain in a certain frequency, instead of using the integrator. By applying these methods to the loop filter 13 in the present embodiment, the frequency range in which the undesired component is suppressible can easily be expanded.

### Second Embodiment

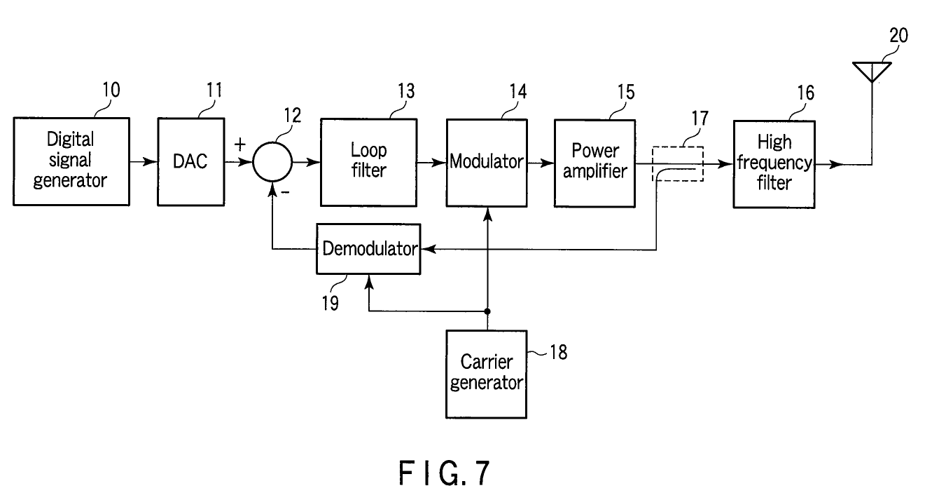

FIG. 7 shows a wireless transmitter according to a second embodiment of the present invention. The difference between the second embodiment and the first embodiment shown in FIG. 1 is that, in the second embodiment, the power divider 17 is placed between the power amplifier 15 and the high frequency filter 16, and the high frequency filter 16 is placed outside the feedback loop. In other words, in the present embodiment, a part of the power of the amplified modulated signal output from the power amplifier 15 is divided by the power divider 17 and input to the demodulator 19 as a feedback modulated signal. In the demodulator 19, the feedback modulated signal is subjected to demodulation using a carrier signal from the carrier generator 18, and a feedback baseband signal is generated.

In a case where the characteristics of the high frequency filter 16 is unfavorable, and, particularly, in the case where a group delay is large, when the high frequency filter is in the feedback loop, the stability of the loop may deteriorate causing the loop to operate improperly. According to the present embodiment, by placing the high frequency filter 16 outside the loop, even in the case where the group delay characteristics of the high frequency filter 16 are unfavorable, the drawbacks as mentioned above can be avoided.

For the power amplifier 15 in the present embodiment, for example, a so called tuned amplifier, which has a characteristic of amplifying only a particular frequency component, is used. Accordingly, since undesired components are also removed to some extent in the power amplifier 15, in some cases, it may also be possible to utilize the output signal of the power amplifier 15 as a feedback signal. However, normally, even if the tuned amplifier is used as the power amplifier 15, since its output signal includes undesired component residues, it is not favorable as a transmit RF signal to be supplied to the antenna 20 in terms of preventing undesired radiation from the transmitter. Therefore, it is desirable to use the high frequency filter 16 to remove these undesired component residues.

Specific Examples of Each Element

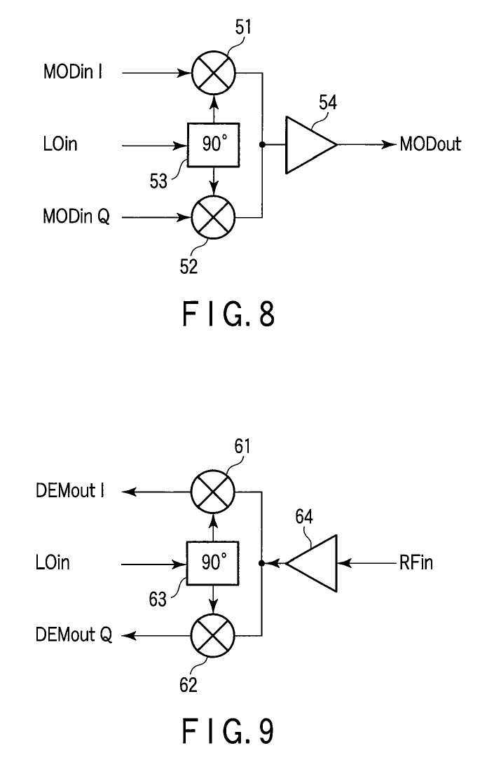

Specific examples of each element shown in FIGS. 1 and 7, particularly, the modulator 14, the demodulator 19 and the DAC 11, will be explained using FIGS. 8 to 12.

Currently, in many digital communication schemes, a scheme which modulates both the amplitude and the phase of a signal is adopted. In other words, transmitted and received signals are handled as an I-channel signal and a Q-channel signal which are quadrature signals presented by orthogonal coordinates. In such case, in the wireless transmitters shown in FIGS. 1 and 7, the digital baseband signal generated by the digital signal generator 10, the analog base band signal output from the DAC 11, the residual signal output from the subtracter 12, the filtered signal output from the loop filter 13 and the feedback baseband signal output from the demodulator 19 are all represented by I-channel signals and Q-channel signals, which are quadrature signals. Further, a quadrature modulator is used as the modulator 14 and a quadrature demodulator is used as the demodulator 19.

<Quadrature Modulator>

FIG. 8 is an example of a quadrature modulator which can be used as the modulator 14, which comprises two multipliers (mixers) 51 and 52, a 90° phase shifter 53 and an output buffer 54. In the quadrature modulator which is the modulator 14, an I-channel signal MODinI and a Q-channel signal MODinQ, which are filtered signals to be modulated output from the loop filter 13 shown in FIG. 1 or 7, and a carrier signal (local signal) LOin from the carrier generator 18 shown in FIG. 1 or 7 are input. The local signal LOin becomes carrier signals having mutual phase difference of 90° by the 90° phase shifter 53.

In the multipliers 51 and 52, each of the two local signals having 90° phase difference are amplitude-modulated by the I-channel signal MODinI and the Q-channel signal MODinQ and added, then output as a modulated signal via the output buffer 54. The phase of the modulated signal output from the output buffer 54 is controlled by the amplitude ratio of the I-channel signal and the Q-channel signal, thereby realizing the modulation of amplitude and phase.

<Quadrature Demodulator>

FIG. 9 is an example of a quadrature demodulator which can be used as the demodulator 19 inserted in the feedback path, which comprises two multipliers (mixers) 61 and 62, a 90° phase shifter 63 and an input buffer 64. In the quadrature demodulator which is the demodulator 19, a transmit RF signal (or the amplified modulated signal from the power divider 17 shown in FIG. 7) RFin from the power divider 17 show in FIG. 1 and a carrier signal (local signal) LOin from the carrier generator 18 shown in FIG. 1 or FIG. 7 are input. The local signal LOin becomes carrier signals having mutual phase difference of 90° by the 90° phase shifter 63.

The signal RFin is input to the multipliers 61 and 62 via the input buffer 64, multiplied by two carrier signals having a 90° phase difference and demodulated, thereby generating an I-channel signal DEMoutI and a Q-channel signal DEMoutQ, which are feedback baseband signals.

<Three-phase Modulator>

In the wireless transmitter shown in FIG. 1 and FIG. 7, the digital baseband signal generated by the digital signal generator 10, the analog baseband signal output from the DAC 11, the residual signal output from the subtracter 12, the filtered signal output from the loop filter 13, and the feedback baseband signal output from the demodulator 19 may be quadrature signals as mentioned above, however, may also be balanced three-phase signals (three-phase signals).

Generally, in the case of realizing the wireless transmitter by an integrated circuit, in many cases, a differential scheme which expresses each of the quadrature signals by the voltage between the two terminals of positive and negative is adopted. Therefore, a circuit which expresses two signals using four terminals is adopted. However, since this circuit is lengthy, two dimensional signals can be expressed by using three terminals. In an extreme case, it is possible to have a terminal among the three terminals as a reference potential, and express the signals by the potentials of the remaining two terminals. However, it is difficult to make a reference potential with small fluctuation on the integrated circuit. Likewise the differential circuit of two terminals which use the average value of potentials of two terminals (referred to as common mode voltage) as a reference potential, a balanced three-phase scheme having the average value of three terminals as the reference potential can be realized by expanding a differential circuit.

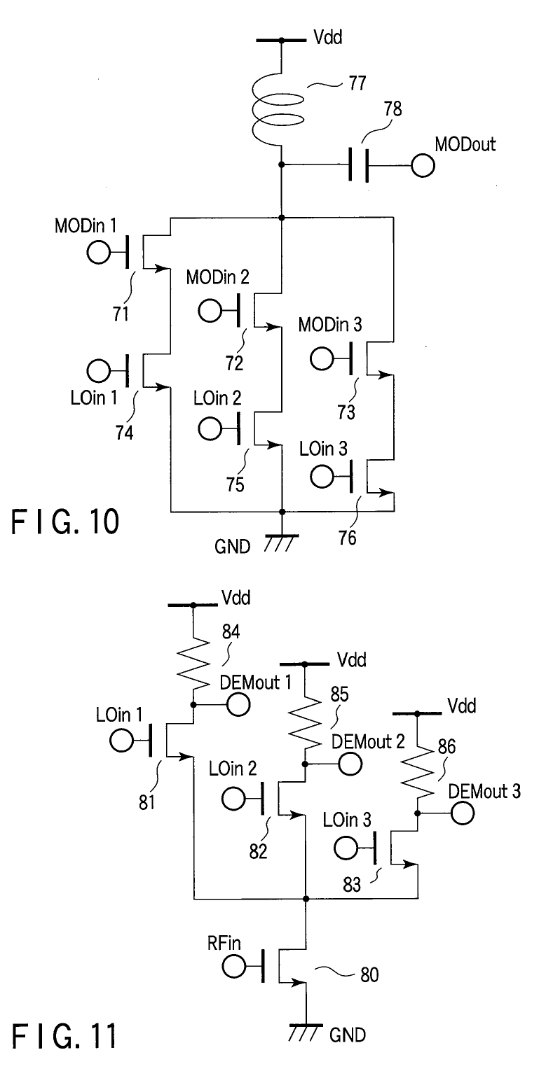

FIG. 10 shows an example of a three-phase modulator which can be used as the modulator 14, based on the above idea. In the three-phase modulator which is the modulator 14, three-phase modulating signals MODin1, MODin2 and MODin3 which are filtered signals from the loop filter 13 shown in FIG. 1 or FIG. 7 to be modulated, and three-phase carrier signals (local signals) LOin1, LOin2 and LOin3 from the carrier generator 18 shown in FIG. 1 or FIG. 7 are input.

The modulating signals MODin1, MODin2 and MODin3 are given to the gate of N-type MOS transistors (NMOS transistor) 71, 72 and 73. The local signals LOin1, Loin2 and LOin3 are given to the gate of transistors 74, 75 and 76. A common drain of the transistors 71, 72 and 73 is connected to a power source Vdd via a load inductor 77, as well as to an output terminal via a capacitor 78. Each source of the transistors 71, 72 and 73 is connected to each drain of the transistors 74, 75 and 76, whose sources are connected to a ground GND. A modulated signal MODout is output from the output terminal by this configuration.

<Three-Phase Demodulator>

FIG. 11 is an example of a three-phase demodulator which can be used as the demodulator 19 inserted in the feedback path, and in which a differential amplification circuit form frequency conversion circuit is extended in three phases. In the three-phase demodulator which is the demodulator 19, the transmit RF signal from the power divider 17 shown in FIG. 1 (or the amplified modulated signal from the power divider 17 shown in FIG. 7) RFin, and the three-phase carrier signals (local signals) LOin1, LOin2 and LOin3 from the carrier generator 18 shown in FIG. 1 or FIG. 7 are input.

The local signals LOin1, LOin2 and LOin3 are given to the gates of NMOS transistors 81, 82 and 83. The modulated signal RFin is given to the gate of NMOS transistor 80. The drains of transistors 81, 82 and 83 are respectively connected to each power source Vdd via load resistances 84, 85 and 86, and connected to three-phase output terminals. The common source of transistors 81, 82 and 83 are connected to the drain of transistor 80, whose source is connected to the ground GND. In such configuration, the three-phase feedback baseband signals DEMout1, DEMout2 and DEMout3 can be obtained from the three-phase output terminals.

<Current Output-Type DAC and Current Output-Type Demodulator>

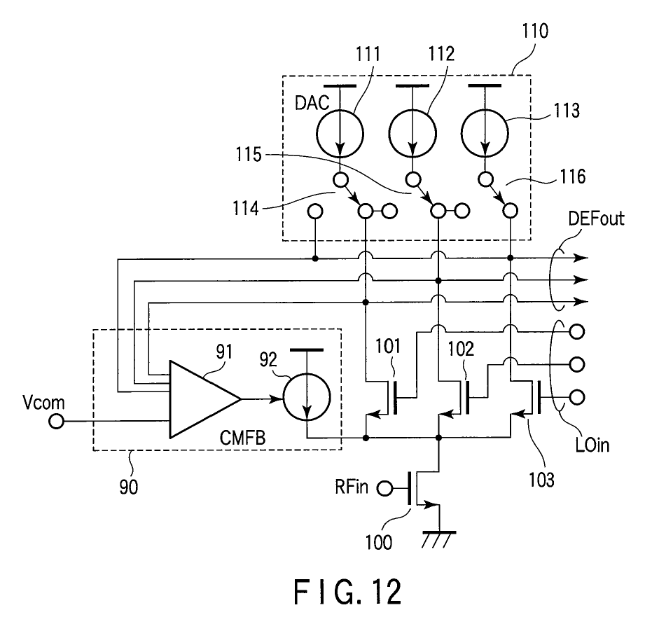

In the wireless transmitter shown in FIG. 1 or FIG. 7, by making both the DAC 11 and the demodulator 19 a current output-type, the subtracter 12 can be realized by a connection. FIG. 12 shows a current output-type three-phase DAC 110 and a current output-type three-phase demodulator showing such example. The current output-type three-phase DAC 110 which corresponds to the DAC 11 includes power sources 111, 112 and 113 which have different current values, and switches 114, 115 and 116 which are switched on/off in accordance with a digital value (the value of the digital baseband signal). The current output-type three-phase DAC 110 outputs an analog baseband signal corresponding to the digital baseband signal output from the digital signal generator 10 shown in FIG. 1 or FIG. 7 as a current signal.

Meanwhile, the current output-type three-phase demodulator corresponding to the demodulator 19 includes the NMOS transistors 100, 101, 102 and 103. The transmit RF signal (or the amplified modulated signal from the power divider 17 shown in FIG. 7) RFin from the power divider 17 shown in FIG. 1 is input to the gate of the transistor 100, and the three-phase carrier signals (local signals) LOin1, LOin2 and LOin3 from the carrier generator 18 shown in FIG. 1 or 7 are input to the gates of the transistors 101, 102 and 103. The drains of transistors 101, 102 and 103 which are the output terminals of the current output-type three-phase demodulator are connected commonly with the output terminals of the current output-type three-phase DAC 110.

In this manner, by having the DAC 11 and the demodulator 19 both in a current output-type configuration and connecting each other's output terminals commonly, the current signals, which are each of the outputs, are subtracted, and the three-phase residual signals DEFout can be obtained. In other words, the function of the subtracter 12 shown in FIG. 1 or FIG. 7 can be realized by connection.

In the case where both the DAC 11 and the demodulator 19 are current output types, since each of the bias currents does not necessarily match, correct subtraction may not be carried out by simply connecting each of the output terminals commonly. Hence, in FIG. 12, a known common mode feedback (CMFB) circuit 90 comprising a calculation amplifier 91 and a current source 92 is used to supply a current corresponding to the difference of the bias current between the DAC and the demodulator, and to control the average voltage of the three-phase residual signals DEFout so that their values become close to the reference voltage Vcom.

In the example of FIG. 12, the three-phase current output-type DAC and the three-phase current output-type demodulator are shown. However, even in the case where the DAC 11 and the demodulator 19 are both single-phase current output-types, subtraction can be carried out by the current signal, by similarly connecting each of the output terminals commonly.

In the above embodiments, a wireless transmitter has been explained. However, it is also possible to use the present invention as a transmitter for wire communication using, for example, a frequency division multiple access scheme.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A transmitter comprising:
a signal generator to generate a digital baseband signal corresponding to a signal to be transmitted;
a digital-analog converter to convert the digital baseband signal into an analog baseband signal by operating in accordance with a clock signal having a predetermined frequency;
a subtracter to subtract a feedback baseband signal from the analog baseband signal to generate a residual signal;
a loop filter to filter the residual signal by amplifying a low-frequency component of the residual signal and suppressing a high-frequency component of the residual signal to generate a filtered signal;
a modulator to modulate the carrier signal by multiplying the filtered signal by a carrier signal to generate a modulated signal;
a power amplifier to amplify the modulated signal to obtain an amplified modulated signal;
a high frequency filter to filter the amplified modulated signal to obtain a transmit RF signal by removing at least a part of an undesired component included in the amplified modulated signal, the high frequency filter having a passband width narrower than the predetermined frequency of the clock signal; and
a demodulator to demodulate a feedback RF signal which is divided from the transmit RF signal by using the carrier signal to generate the feedback baseband signal.

2. The transmitter according to claim 1, wherein the subtracter, the loop filter, the modulator, the power amplifier, the high frequency filter and the demodulator form a feedback loop, the feedback loop being configured to remove components within the passband of the high frequency filter among the undesired components.

3. The transmitter according to claim 1, further comprising an antenna to transmit the transmit RF signal.

4. The transmitter according to claim 1, wherein the loop filter is an integrator.

5. The transmitter according to claim 1, wherein the analog baseband signal, the residual signal, the filtered signal and the feedback baseband signal are quadrature signals.

6. The transmitter according to claim 1, wherein the analog baseband signal, the residual signal, the filtered signal and the feedback baseband signal are balanced three-phase signals.

7. The transmitter according to claim 1, wherein the digital-analog converter is configured to output the analog baseband signal as a first current signal from at least a first output terminal, and the demodulator is configured to output the feedback baseband signal as a second current signal from at least a second output terminal, the first output terminal and the second output terminal commonly connected to subtract the second current signal from the first current signal, thereby generating the residual signal.

8. A transmitter comprising:
a signal generator to generate a digital baseband signal corresponding to a signal to be transmitted;
a digital-analog converter to convert the digital baseband signal into an analog baseband signal by operating in accordance with a predetermined frequency clock signal;
a subtracter to subtract a feedback baseband signal from the analog baseband signal to generate a residual signal;
a loop filter to filter the residual signal by amplifying a low-frequency component of the residual signal and suppressing a high-frequency component of the residual signal to generate a filtered signal;
a modulator to modulate the carrier signal by multiplying the filtered signal by a carrier signal to generate a modulated signal;
a power amplifier to amplify the modulated signal to obtain an amplified modulated signal;
a demodulator to demodulate a feedback RF signal which is divided from the amplified modulated signal by using the carrier signal to generate the feedback baseband signal; and
a high frequency filter to filter the amplified modulated signal to obtain a transmit RF signal by removing at least a part of an undesired component included in the amplified modulated signal, the high frequency filter having a passband width narrower than a frequency of the clock signal.

9. The transmitter according to claim 8, wherein the subtracter, the loop filter, the modulator, the power amplifier and the demodulator form a feedback loop, the feedback loop being configured to remove components within the passband of the high frequency filter among the undesired components.

10. The transmitter according to claim 8, further comprising an antenna to transmit the transmit RF signal.

11. The transmitter according to claim 8, wherein the loop filter is an integrator.

12. The transmitter according to claim 9, wherein the analog baseband signal, the residual signal, the filtered signal and the feedback baseband signal are quadrature signals.

13. The transmitter according to claim 9, wherein the analog baseband signal, the residual signal, the filtered signal and the feedback baseband signal are balanced three-phase signals.

14. The transmitter according to claim 9, wherein the digital-analog converter is configured to output the analog baseband signal as a first current signal from at least a first output terminal, and the demodulator is configured to output the feedback baseband signal as a second current signal from at least a second output terminal, the first output terminal and the second output terminal commonly connected to subtract the second current signal from the first current signal, thereby generating the residual signal.
